(19) United States
(12) Patent Application Publication
(10) Pub. No.: US 2022/0375040 A1
(43) Pub. Date: Nov. 24, 2022

(54) IMAGE PROCESSING APPARATUS, IMAGE PROCESSING METHOD, PROGRAM, AND ELECTRONIC DEVICE

(71) Applicant: SONY GROUP CORPORATION, TOKYO (JP)

(72) Inventors: KAZUHIKO NISHIBORI, TOKYO (JP); SHIHHAO WEN, TOKYO (JP); TAKAMITSU GOTO, TOKYO (JP)

(21) Appl. No.: 17/754,305

(22) PCT Filed: Jul. 17, 2020
(86) PCT No.: PCT/JP2020/027812

§ 371 Date: Mar. 29, 2022

(30) Foreign Application Priority Data
Oct. 9, 2019 (JP) 2019-185782

(51) Int. Cl. G06T 5/00; G06T 7/11; G06T 5/20

(52) U.S. Cl. CPC G06T 5/002; G06T 5/004; G06T 7/11; G06T 5/20

(57) ABSTRACT

A human region detection unit 32 of a mask generation unit 31 detects a target region from a captured image using a region determination result obtained by semantic segmentation, and a difference region detection result. A mask generation processing unit 33 resets a boundary between a target region and a non-target region on the basis of continuity of a pixel value of a captured image, in a boundary re-search region set to include a target region and a non-target region on the basis of a boundary between the target region and the non-target region, such as a background region, that is indicated by a region determination result, and generates a target region mask using the reset boundary. A filtering unit 35 generates an image in which a background region is blurred, by performing filter processing of a region in a captured image that corresponds to a target region mask, using a target region mask generated by the mask generation unit 31, and a blurring filter coefficient set by a filter setting unit 34. It becomes possible to perform background blurring with a small amount of artifact.

### TECHNICAL FIELD

The present technology relates to an image processing apparatus, an image processing method, a program, and an electronic device, and enables background blurring with a small amount of artifact to be performed.

### BACKGROUND ART

Conventionally, an electronic device having an image capturing function, such as a camera mounted on a smartphone, for example, has been unable to obtain an image in which a background is greatly blurred as in an image captured by a single-lens reflex camera because a focus is put on a relatively-wider distance range as compared with the single-lens reflex camera. Thus, in Patent Document 1, a distance map of a subject is generated from a plurality of captured images with different focus conditions, performs filter processing on each subject the number of times that is based on a distance indicated by the distance map, and generates an image in which a background is greatly blurred, for example, by synthesizing images generated each time filter processing is performed.

### CITATION LIST

### Patent Document

Patent Document 1: Japanese Patent Application Laid-Open No. 2015-159357

### SUMMARY OF THE INVENTION

### Problems to be Solved by the Invention

Meanwhile, in Patent Document 1, because a distance map of a subject is to be generated from a plurality of captured images with different focus conditions, the technology cannot be applied to a camera in which a focus condition cannot be changed during image capturing.

In view of the foregoing, the present technology aims to provide an image processing apparatus, an image processing method, a program, and an electronic device that can perform background blurring with a small amount of artifact without performing image capturing while changing a focus condition.

### Solutions to Problems

The first aspect of the present technology is an image processing apparatus including a mask generation unit configured to detect a target region from a captured image, and generate a target region mask from features of the target region and a non-target region different from the target region, and a filtering unit configured to generate a non-target region blurred image by performing filter processing of the captured image using the target region mask generated by the mask generation unit, and a blurring filter coefficient.

In the present technology, the mask generation unit detects the target region from the captured image using a region determination result obtained by semantic segmentation, for example. Furthermore, the mask generation unit detects a difference region between a captured image used in semantic segmentation, and a captured image including a target region partially different from that of the captured image, detects a difference region between a captured image obtained by capturing an image of a targeted subject, and a captured image obtained by capturing an image of a subject, in which only a predetermined portion of the targeted subject is moved to a position not overlapping a background region, for example, performs semantic segmentation using a captured image obtained by capturing an image of a subject, in which a predetermined portion of the targeted subject is moved to a position not overlapping a background region, and generates a region determination result by synthesizing the target region determined by the semantic segmentation, with the difference region.

The mask generation unit resets a boundary between a target region and a non-target region on the basis of continuity of a pixel value of a captured image, in a boundary re-search region set to include a target region and a non-target region on the basis of a boundary between the target region and the non-target region, such as a background region, that is indicated by a region determination result, and generates a target region mask using the reset boundary.

The filtering unit generates a non-target region blurred image by performing filter processing of a region in a captured image that corresponds to a target region mask, using a target region mask generated by a mask generation unit, and a blurring filter coefficient. The filtering unit may make a blurring filter coefficient switchable to a coefficient with a different blurring characteristic, and make the number of taps of filter processing switchable.

The filtering unit sets a filter coefficient of an impulse response as the target region filter coefficient, sets a lowpass filter coefficient as the blurring filter coefficient, and switches a filter coefficient to the target region filter coefficient in the target region and to the blurring filter coefficient in the non-target region on the basis of the target region mask.

The filtering unit performs generation of a target region filter coefficient map and a non-target region filter coefficient map on the basis of the target region mask, the target region filter coefficient, and the blurring filter coefficient for each component of a filter coefficient, generates a target region image on the basis of the target region filter coefficient map and the captured image, generates a non-target region image on the basis of the non-target region filter coefficient map and the captured image, and performs filter processing by accumulating the target region image and the non-target region image of each component of the filter coefficient for each pixel.

The second aspect of the present technology is an image processing method including detecting a target region from a captured image, and generating a target region mask from features of the target region and a non-target region different from the target region, by a mask generation unit, and generating a non-target region blurred image by a filtering unit by performing filter processing of the captured image using the target region mask generated by the mask generation unit, and a blurring filter coefficient.

The third aspect of the present technology is a program for causing a computer to execute image processing of a captured image, the program causing the computer to execute a procedure of detecting a target region from the captured image, and generating a target region mask from features of the target region and a non-target region different from the target region, and a procedure of generating a non-target region blurred image by performing filter processing of the captured image using the target region mask and a blurring filter coefficient.

Note that the program of the present technology is a program that can be provided to a general-purpose computer that can execute various program codes, for example, by a storage medium or a communication medium that provides the program in a computer-readable format, a storage medium such as an optical disk, a magnetic disk, or a semiconductor memory, for example, or a communication medium such as a network. By providing such a program in a computer-readable format, processing corresponding to the program is executed on the computer.

The fourth aspect of the present technology is an electronic device including an imaging unit configured to generate a captured image, a mask generation unit configured to detect a target region from the captured image, and generate a target region mask from features of the target region and a non-target region different from the target region, a filtering unit configured to generate a non-target region blurred image by performing filter processing of the captured image using the target region mask generated by the mask generation unit, and a blurring filter coefficient, and a display unit configured to display the non-target region blurred image.

### BRIEF DESCRIPTION OF DRAWINGS

FIG. 1 is a diagram exemplifying a configuration of an electronic device.

FIG. 2 is a diagram exemplifying a configuration of a human region detection unit.

FIG. 3 is a diagram exemplifying a configuration of a human mask generation unit.

FIG. 4 is a diagram exemplifying a configuration of a boundary resetting unit.

FIG. 5 is a diagram exemplifying a configuration of a cost map generation unit.

FIG. 6 is a diagram exemplifying a configuration of a boundary resetting unit.

FIG. 7 is a flowchart exemplifying an operation of an embodiment.

FIG. 8 is a diagram exemplifying an operation in a synthesis mode.

FIG. 9 is a diagram for describing mask generation processing.

FIG. 10 is a diagram for describing generation of a cost map.

FIG. 11 is a diagram exemplifying a cost map.

FIG. 12 is a diagram exemplifying filter coefficients used in filter processing.

FIG. 13 is a diagram exemplifying filter coefficients of a boundary portion of a human region and a background region.

FIG. 14 is a diagram exemplifying an image not subjected to filter processing and an image having been subjected to filter processing, and the like.

FIG. 15 is a flowchart (1/2) exemplifying a filter processing operation.

FIG. 16 is a flowchart (2/2) exemplifying a filter processing operation.

FIG. 17 is a diagram exemplifying a captured image, a human mask image, and an output image.

### MODE FOR CARRYING OUT THE INVENTION

Hereinafter, a mode for carrying out the present technology will be described. Note that the description will be given in the following order.

1. Configuration of Embodiment

2. Operation of Embodiment

### 1. Configuration of Embodiment

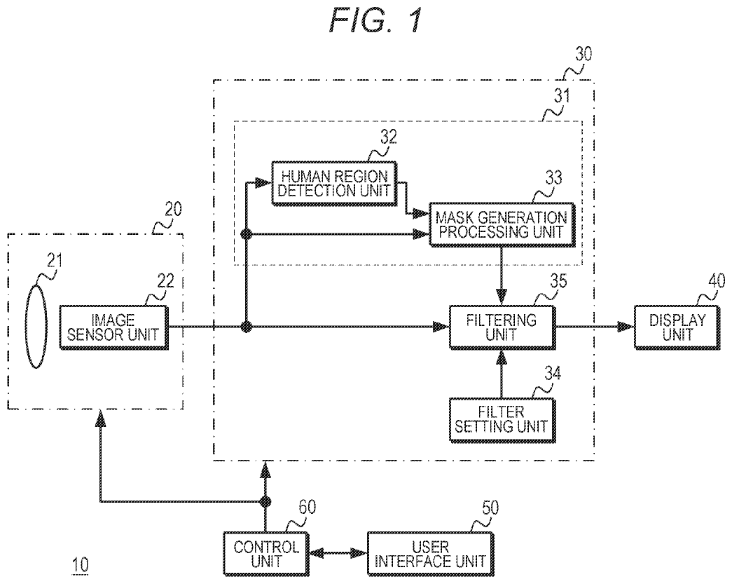

FIG. 1 exemplifies a configuration of an electronic device that uses an image processing apparatus of the present technology. An electronic device 10 includes an imaging unit 20, an image processing unit 30, a display unit 40, a user interface unit 50, and a control unit 60. The electronic device 10 acquires a captured image using the imaging unit 20, and the image processing unit 30 performs image processing of causing a non-target region in the acquired captured image to become a blurred image.

The imaging unit 20 includes an imaging optical system 21 and an image sensor unit 22. The imaging optical system 21 includes a focus lens, a zoom lens, and the like, and forms a subject optical image onto an imaging plane of the image sensor unit 22 in a desired size.

The image sensor unit 22 includes an image sensor such as a complementary metal oxide semiconductor (CMOS) image sensor or a charge coupled device (CCD) image sensor. The image sensor unit 22 performs photoelectric conversion, generates an image signal corresponding to the subject optical image, and outputs the image signal to the image processing unit 30. Note that the image sensor unit 22 may be provided with a preprocessing unit, and processing such as noise removal and gain adjustment, analog/digital conversion processing, defective pixel correction, and the like may be performed on an imaging signal generated by an imaging element. Furthermore, in a case where a color mosaic filter is used in an image sensor, the image sensor unit 22 may be provided with a demosaic processing unit, and the demosaic processing unit may perform demosaic processing using the imaging signal processed by the preprocessing unit, and generate an image signal in which one pixel indicates each color component, such as a primary-colors image signal, from an imaging signal in which one pixel indicates one color component.

The electronic device 10 includes a normal mode for performing image processing on a captured image obtained in one image capturing, and a synthesis mode for performing image processing by synthesizing a plurality of types of region determination results because a target region (or a non-target region) cannot be accurately detected in the normal mode. In the synthesis mode, as described later, for example, image processing is performed by synthesizing a plurality of types of region detection that is based on a captured image obtained by capturing an image of a targeted subject, and a captured image obtained by capturing an image of a subject, in which a predetermined portion of the targeted subject is moved to a position not overlapping a non-target region.

The image processing unit 30 performs filter processing using an image signal of a captured image generated by the imaging unit 20, and generates an image in which a non-target region in the captured image is blurred. In other words, the image processing unit 30 detects a target region from a captured image, and generates a target region mask from the features of a target region and a non-target region. Moreover, the image processing unit 30 performs filter processing of a captured image using the target region mask and a blurring filter coefficient, and generates a non-target region blurred image. Note that, in the following description, for example, a target region is regarded as a human region and a non-target region is regarded as a background region. Furthermore, the details of an operation of each component will be described in Operation of Embodiment.

The image processing unit 30 includes a mask generation unit 31, a filter setting unit 34, and a filtering unit 35. Furthermore, the mask generation unit 31 includes a human region detection unit 32 and a mask generation processing unit 33, detects a human region from a captured image, and generates a human mask from the features of the human region and the background region.

The human region detection unit 32 detects a human region in a captured image using an image signal supplied from the imaging unit 20 after an imaging operation is performed in the normal mode or the synthesis mode. For example, the human region detection unit 32 detects a human region by performing semantic segmentation and determining whether each pixel in the captured image is a pixel of the human region or a pixel of the background region. Furthermore, in a case where an imaging operation is performed in the synthesis mode, the human region detection unit 32 detects a difference region between a captured image used in semantic segmentation, and a captured image including a target region partially different from that of the captured image, and generates a region determination result of the human region by synthesizing the target region determined in the semantic segmentation, and the difference region. Note that, as described later, by the mask generation processing unit 33 re-searching a boundary between the human region and the background region using the human region determination result, the human region detection unit 32 performs the detection of a human region using a reduced captured image while prioritizing a processing speed over accuracy, for example.

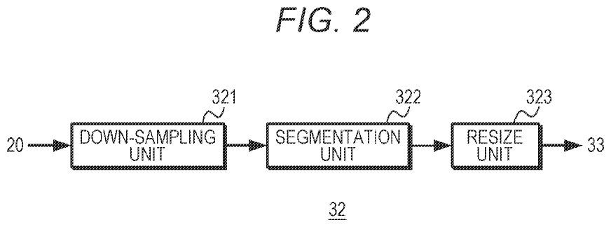

FIG. 2 exemplifies a configuration of the human region detection unit. The human region detection unit 32 includes a down-sampling unit 321, a segmentation unit 322, and a resize unit 323.

The down-sampling unit 321 generates a reduced captured image by performing down-sampling of an image signal supplied from the imaging unit 20.

The segmentation unit 322 performs convolutional neural network (CNN), for example, and generates a segmentation map of a detection target region. In the segmentation unit 322, learning that uses a human image is preliminarily performed. Using a learning result, the segmentation unit 322 performs the CNN of the detection target region, and generates a segmentation map being a binary image in which each pixel is labelled with a human or another attribute. Furthermore, in a case where an imaging operation is performed in the synthesis mode, the segmentation unit 322 detects a difference region between a captured image used in semantic segmentation, and a captured image including a target region partially different from that of the captured image, and generates a segmentation map by synthesizing the target region determined in the semantic segmentation, and the difference region.

By performing interpolation processing, for example, on the segmentation map generated by the segmentation unit 322, the resize unit 323 resizes the segmentation map to a size before down-sampling, and outputs the segmentation map to the mask generation processing unit 33 as a segmentation map corresponding to the detection target region in the captured image.

On the basis of the segmentation map generated by the human region detection unit 32, the mask generation processing unit 33 sets a boundary re-search region with a predetermined width that includes a boundary line of the human region and the background region. Moreover, the mask generation processing unit 33 generates a human mask covering over the human region, on the basis of color continuity of adjacent pixels in the boundary re-search region.

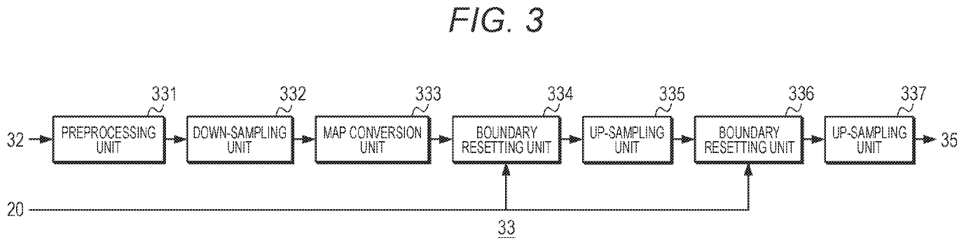

FIG. 3 exemplifies a configuration of the human mask generation unit. Note that FIG. 3 illustrates a configuration of achieving stabilization of a mask by performing processing with resolutions in a plurality of hierarchies, and generating a highly-accurate human mask. The mask generation processing unit 33 includes a preprocessing unit 331, a down-sampling unit 332, a map conversion unit 333, a boundary resetting unit 334, an up-sampling unit 335, a boundary resetting unit 336, and an up-sampling unit 337.

As preprocessing, the preprocessing unit 331 performs noise removal and the like of the segmentation map generated by the human region detection unit 32. For example, the preprocessing unit 331 performs filter processing of the segmentation map using a smoothing filter, a median filter, or the like, and outputs the preprocessed segmentation map to the down-sampling unit 332.

The down-sampling unit 332 down-samples the segmentation map supplied from the preprocessing unit 331, and a captured image generated by the imaging unit 20, to a basic plane (for example, ¼ resolution both in horizontal and vertical directions), and outputs the segmentation map and the captured image to the map conversion unit 333.

The map conversion unit 333 converts the segmentation map of a binary image being the region determination result detected by the human region detection unit 32, into a map of a ternary image. The map conversion unit 333 sets a boundary re-search region with a predetermined width that includes a human region and a background region, based on a boundary between the human region and the background region that is indicated in the segmentation map, and converts the segmentation map into a map (hereinafter, referred to as “Trimap”) indicating three regions in which “2” is set to pixels in the boundary re-search region, “1” is set to pixels in the human region in the segmentation map that excludes the boundary re-search region, and “0” is set to pixels in the background region in the segmentation map that excludes the boundary re-search region, for example.

On the basis of the Trimap generated by the map conversion unit 333, the boundary resetting unit 334 generates a cost map regarding continuity of pixel values in a captured image, resets a boundary between the human region and the background region on the basis of the cost map, and generates a highly-accurate Trimap by using the reset boundary.

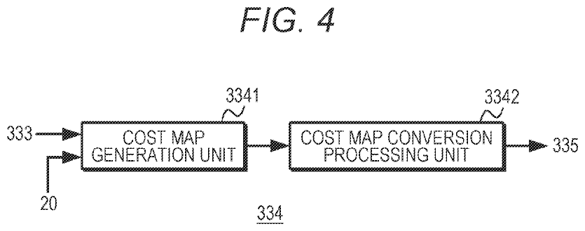

FIG. 4 exemplifies a configuration of the boundary resetting unit. The boundary resetting unit 334 includes a cost map generation unit 3341 and a cost map conversion processing unit 3342.

The cost map generation unit 3341 sets a pixel in a human region as a virtual foreground node, a pixel in a background region as a virtual background node, and a pixel in a boundary re-search region as an unknown node, generates a cost map on the basis of cost at an edge existing on a path connecting the virtual foreground node and the unknown node, and cost at an edge existing on a path connecting the virtual background node and the unknown node, and outputs the cost map to the cost map conversion processing unit 3342.

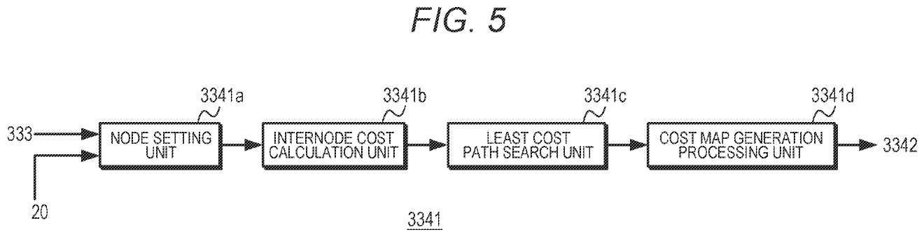

FIG. 5 exemplifies a configuration of the cost map generation unit. The cost map generation unit 3341 includes a node setting unit 3341a, an internode cost calculation unit 3341b, a least cost path search unit 3341c, and a cost map generation processing unit 3341d.

In the Trimap generated by the map conversion unit 333, for example, the node setting unit 3341a sets a pixel in the boundary re-search region as a search node, a pixel in a human region adjacent the boundary re-search region, or a pixel in a human region existing in a range up to a position separated from the boundary re-search region by a plurality of pixels, as a virtual foreground node, and a pixel in a background region adjacent the boundary re-search region, or a pixel in a background region existing in a range up to a position separated from the boundary re-search region by a plurality of pixels, as a virtual background node.

Using pixel values of a captured image generated by the imaging unit 20, the internode cost calculation unit 3341b calculates cost indicating continuity of pixel values between adjacent nodes. For example, the internode cost calculation unit 3341b calculates a difference in pixel value between adjacent nodes among nodes set by the node setting unit 3341a, as internode cost. Thus, cost becomes smaller between pixels having continuity.

Using each internode cost calculated by the internode cost calculation unit 3341b, the least cost path search unit 3341c determines a least cost path connecting a virtual foreground node and a virtual background node, for each of virtual foreground nodes and virtual background nodes.

The cost map generation processing unit 3341d determines pixels indicating a boundary, on the basis of a cost accumulated value of least cost paths, generates a cost map indicating which of a human region and a background region each pixel in a captured image represents, on the basis of the determination result, and outputs the cost map to the cost map conversion processing unit 3342.

On the basis of cost indicated by the cost map having been subjected to filter processing, the cost map conversion processing unit 3342 resets a boundary between a human region and a background region in a boundary re-search region, and performs map conversion into a Trimap that uses the reset boundary. In the map conversion, a boundary between a human region and a background region is searched for again on the basis of cost indicated by the cost map, and the Trimap is converted into double resolution of the basic plane by the up-sampling unit 335 to be described later. Thus, a region width of the boundary re-search region in the Trimap is narrowed as compared with a case where the Trimap is generated by the map conversion unit 333. The cost map conversion processing unit 3342 outputs the converted Trimap to the up-sampling unit 335.

The up-sampling unit 335 performs up-sampling of the Trimap supplied from the cost map conversion processing unit 3342, generates a Trimap with double resolution (1/2 resolution) of the basic plane, and outputs the Trimap to the boundary resetting unit 336.

The boundary resetting unit 336 generates a cost map on the basis of the Trimap supplied from the up-sampling unit 335, and generates a human mask by performing binarization processing of the cost map.

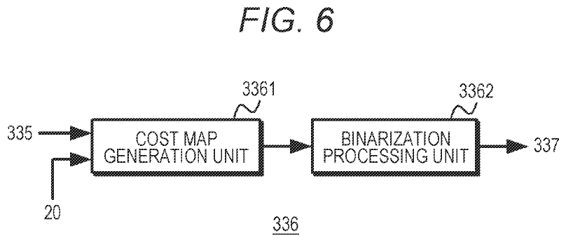

FIG. 6 exemplifies a configuration of the boundary resetting unit. The boundary resetting unit 336 includes a cost map generation unit 3361 and a binarization processing unit 3362.

The cost map generation unit 3361 generates a cost map by performing processing similar to the above-described cost map generation unit 3341, and outputs the cost map to the binarization processing unit 3362.

On the basis of cost indicated by the cost map having been subjected to filter processing, the binarization processing unit 3362 resets a boundary between a human region and a background region in a boundary re-search region, generates a human mask being a binary image indicating a human region and a background region, and outputs the human mask to the up-sampling unit 337.

The up-sampling unit 337 performs up-sampling of the human mask supplied from the binarization processing unit 3362, generates a human mask with quadruple resolution of the basic plane (i.e., resolution equal to that of a captured image acquired by the imaging unit 20), and outputs the human mask to the filtering unit 35.

In this manner, by generating a human mask with resolution equal to that of a captured image by performing processing of generating a cost map with low resolution from a captured image and a human detection result with low resolution, and newly generating a cost map with high resolution from the cost map with low resolution, it becomes possible to smoothen a boundary line between a human mask and another region as compared with a case where a human mask with resolution of a captured image is generated from a human detection result of a captured image with resolution not decreased, and the captured image.

The filter setting unit 34 outputs, to the filtering unit 35, a coefficient (hereinafter, referred to as “blurring filter coefficient”) for performing filter processing in such a manner that a background region in a captured image supplied from the imaging unit 20 becomes a blurred image. The filter setting unit 34 may preliminarily have blurring filter coefficients with different blurring characteristics, and output a blurring filter coefficient selected in accordance with a selection operation of a user, to the filtering unit 35. The blurring filter coefficient may be preset in such a manner that a background region becomes an image in which lens defocus occurs, for example. Furthermore, the filter setting unit 34 may set human region filter coefficients to be used in filter processing of a human region. The human region filter coefficients are set in such a manner as not to decrease sharpness of an edge of a human region, for example. Moreover, the filter setting unit 34 may be enabled to switch not only filter coefficients but also the number of taps. In this manner, by making blurring filter coefficients and the number of taps switchable, it becomes possible to generate a blurred image with a blurring characteristic desired by the user.

The filtering unit 35 generates a background region blurred image by performing filter processing of a captured image using the human mask generated by the mask generation processing unit 33, and the blurring filter coefficient set by the filter setting unit 34. Furthermore, the filtering unit 35 may perform filter processing of a captured image using the human mask and the human filter coefficient set by the filter setting unit 34, and generate an image including a blurred background region, and a human region having been subjected to filter processing corresponding to the human filter coefficient. In this case, the filtering unit 35 performs filter processing of a captured image generated by the imaging unit 20, by controlling the human region filter coefficient set by the filter setting unit 34 and the background region filter coefficient, on the basis of the human mask. By performing filter processing on the basis of the human region filter coefficient, the background region filter coefficient, and the human mask, the filtering unit 35 generates a captured image in which edge sharpness of a human region is maintained, lens defocus occurs in a background region, and color mixture from one region to another region does not occur and unnaturalness is not felt at a boundary between a human region and a background region.

The display unit 40 in FIG. 1 displays a captured image having been subjected to image processing, on the basis of an image signal output from the image processing unit 30. Furthermore, the display unit 40 performs display related to various setting states and various operations of the electronic device 10.

The user interface unit 50 includes an operation switch, an operation button, a touch panel, and the like, and can perform various setting operations and instruction operations on the electronic device 10. For example, the user interface unit 50 can perform a selection operation of the normal mode or the synthesis mode, an adjustment operation of a blurred state (switching of blurring filter coefficient, the number of filter taps, and the like), and the like.

The control unit 60 includes a central processing unit (CPU), a read only memory (ROM), a random access memory (RAM), and the like. The read only memory (ROM) stores various programs to be executed by the central processing unit (CPU). The random access memory (RAM) stores information such as various parameters. By executing various programs stored in the ROM, the CPU controls each component in such a manner that an operation corresponding to a user operation performed on the user interface unit 50 is performed by the electronic device 10.

Note that the electronic device 10 may be provided with a recording unit for recording a captured image acquired by the imaging unit 20, a captured image on which image processing is performed by the image processing unit 30, and the like.

### 2. Operation of Embodiment

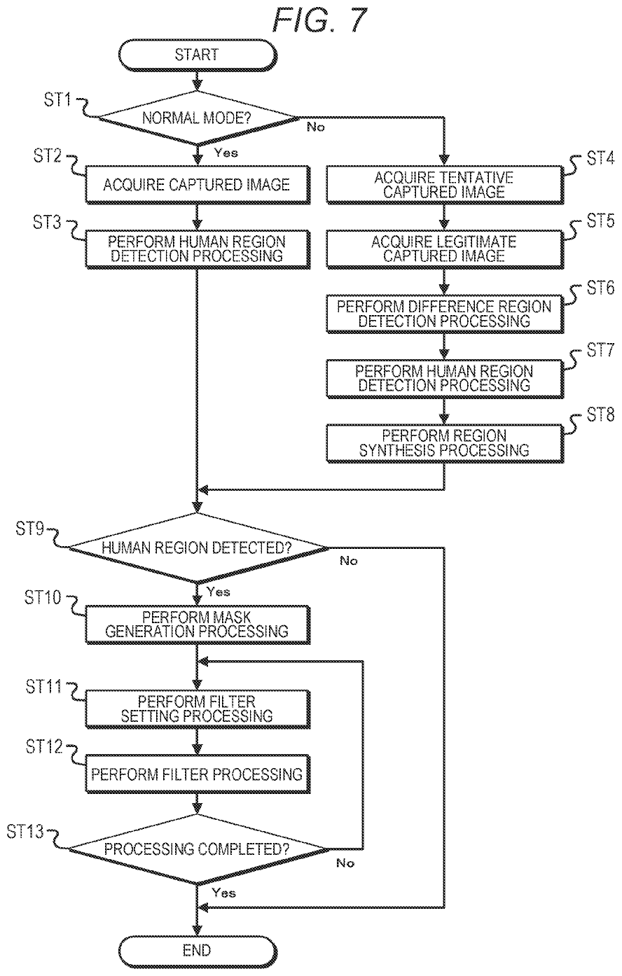

Next, an operation of an embodiment will be described. FIG. 7 is a flowchart exemplifying an operation of an embodiment.

In Step ST1, the electronic device determines whether or not the electronic device is in the normal mode. In a case where the control unit 60 of the electronic device 10 determines that the electronic device 10 is in the normal mode, the processing proceeds to Step ST2, and in a case where the electronic device 10 is not in the normal mode, the processing proceeds to Step ST4. For example, in a case where the control unit 60 determines that the user has selected the synthesis mode because the detection of a human region is not performed accurately in the processing in the normal mode set as a default mode, the processing proceeds to Step ST4.

In Step ST2, the electronic device acquires a captured image. The imaging unit 20 of the electronic device 10 performs image capturing at a timing that is based on a user operation, on the basis of a control signal from the control unit 60, and acquires a captured image of a targeted human, and the processing proceeds to Step ST3.

In Step ST3, the electronic device performs human region detection processing. The image processing unit 30 of the electronic device 10 detects a human region from the captured image acquired in Step ST2, and the processing proceeds to Step ST9.

In Step ST4, the electronic device acquires a tentative captured image. In the synthesis mode, image capturing is performed twice, for example. In first image capturing, a tentative captured image is acquired by performing image capturing after moving a predetermined portion of a targeted human to a position not overlapping a background where region recognition is difficult. In second image capturing, a legitimate captured image is acquired by performing image capturing after returning the predetermined portion to an original position. Whichever of the first image capturing and the second image capturing may be performed earlier. The imaging unit 20 of the electronic device 10 performs the first image capturing, for example, and acquires a tentative captured image in which a predetermined portion of a targeted human falls outside a background, and the processing proceeds to Step ST5.

In Step ST5, the electronic device acquires a legitimate captured image. The imaging unit 20 of the electronic device 10 performs the second image capturing and acquires a legitimate captured image in which the predetermined portion of the targeted human is returned to the original position, and the processing proceeds to Step ST6.

Note that the timing at which the captured image is acquired in Step ST2, the timing at which the tentative captured image is acquired in Step ST4, and the timing at which the legitimate captured image is acquired in Step ST5 are not limited to timings corresponding to a shutter button operation of the user, and may be a timing automatically set using a timer function, or may be a timing at which the user performs predetermined gesture (for example, wink operation or the like). Furthermore, in a case where a tentative captured image and a legitimate captured image are acquired, the second image capturing may be performed when a scene change is detected after the first image capturing.

In Step ST6, the electronic device performs difference region detection processing. The image processing unit 30 of the electronic device 10 detects a difference region (i.e., an image region indicating the predetermined portion in the targeted human) from the tentative captured image acquired in Step ST4 and the legitimate captured image acquired in Step ST5, and the processing proceeds to Step ST7.

In Step ST7, the electronic device performs human region detection processing. The image processing unit 30 of the electronic device 10 detects a human region from the tentative captured image acquired in Step ST4, and the processing proceeds to Step ST8.

In Step ST8, the electronic device performs region synthesis processing. The image processing unit 30 of the electronic device 10 newly sets, as a human region, a region obtained by synthesizing the difference region detected in Step ST6 and the human region detected in Step ST7, and the processing proceeds to Step ST9.

In Step ST9, the electronic device determines whether or not a human region has been detected. In a case where a human region has been detected, the image processing unit 30 of the electronic device 10 advances the processing to Step ST10, and in a case where a human region has not been detected, the image processing unit 30 ends the processing.

In Step ST10, the electronic device performs mask generation processing. The mask generation unit 31 generates a Trimap after performing noise removal of a segmentation map indicating a detection result of a human region, as described above, and down-sampling the captured image and the noise-removed segmentation map to the basic plane. On the basis of the Trimap, the mask generation unit 31 performs generation of a cost map, processing of converting the cost map into a Trimap, and binarization processing of the cost map, and generates a human mask with resolution equal to the captured image, and the processing proceeds to Step ST11.

In Step ST11, the electronic device performs filter setting processing. The image processing unit 30 of the electronic device 10 sets the number of taps and blurring filter coefficients to be used when filter processing is performed in such a manner that a background region becomes a desired blurred image, and the processing proceeds to Step ST12. Note that the number of taps and blurring filter coefficients may be preset, for example, and the number of taps and filter coefficients of a blurring mode selected by the user from among a plurality of preset blurring modes may be used. Moreover, the number of taps and filter coefficients designated by the user may be used. As a blurring mode, for example, a blurring mode for generating circular defocus (spherical defocus) at a point source of light included in a background, a blurring mode for generating star-shaped blurring, a blurring mode with a small blurring amount as in a case where a background is close to a human region, a blurring mode with a large blurring amount as in a case where a background is distant from a human region, or the like is used.

In Step ST12, the electronic device performs filter processing. The image processing unit 30 of the electronic device 10 performs filter processing using the human mask generated in Step ST10, and the number of filter taps and the blurring filter coefficients that have been set in Step ST11, and the processing proceeds to Step ST13.

In Step ST13, the electronic device determines whether or not the processing has been completed. In a case where a resetting operation of a blurred state is performed by the user, the control unit of the electronic device 10 returns the processing to Step ST11, and a new filter coefficient is reset. Furthermore, in a case where a resetting operation of a blurred state is not performed, the control unit of the electronic device 10 ends the processing.

Next, an operation in the synthesis mode will be described. In the synthesis mode, a difference region between a captured image used in semantic segmentation, and a captured image including a human region partially different from that of the captured image is detected, and a region determination result is generated by synthesizing the human region determined in the semantic segmentation, and the difference region.

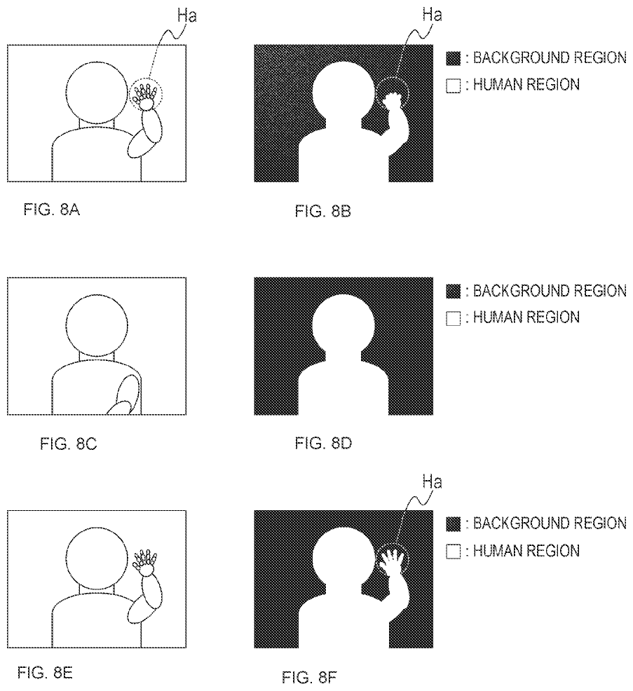

FIG. 8 exemplifies an operation in the synthesis mode. (a) of FIG. 8 exemplifies a captured image including a portion where region detection is difficult, and (b) of FIG. 8 exemplifies a case where a human region is detected using the captured image in (a) of FIG. 8. In the semantic segmentation, a small-sized portion such as fingers and a hand is broadly detected as a human region in some cases, and a part or all of a small-sized portion fails to be detected as a human region in other cases. Note that (b) of FIG. 8 exemplifies a case where fingertips fail to be detected as a human region in a region Ha indicated by a broken line. In the synthesis mode, the first image capturing is performed in a state in which a predetermined portion in a targeted human being a small-sized portion such as fingers and a hand, which is a portion where region recognition is difficult in semantic segmentation, is moved to a position not overlapping a background region, and a tentative captured image illustrated in (c) of FIG. 8, for example, is acquired. Furthermore, the second image capturing is performed in a state in which the predetermined portion in the targeted human is returned to the original position, and a legitimate captured image illustrated in (e) of FIG. 8, for example, is acquired.

Here, if semantic segmentation is performed using the tentative captured image illustrated in (c) of FIG. 8, for example, a human region is detected as illustrated in (d) of FIG. 8. Furthermore, if difference region detection processing is performed using the captured images illustrated in (c) of FIG. 8 and FIG. 8(e), in a difference region, the predetermined portion that has moved to the position not overlapping a background region can be detected. Thus, if the difference region detected by the difference region detection, and the human region detected by semantic segmentation as illustrated in (d) of FIG. 8 are synthesized, a human region can be accurately detected as illustrated in (f) of FIG. 8, without a portion where region recognition is difficult failing to be recognized as a human region, or without the portion being broadly recognized as a human region.

Meanwhile, in a case where the electronic device 10 is not fixed when the first image capturing and the second image capturing are performed, such as a case where the electronic device 10 is held by a hand, a difference region includes a difference caused by camera shake or the like. Thus, by performing motion detection of the electronic device 10 and performing motion correction of a captured image acquired in the second image capturing, on the basis of a motion detection result, it is possible to prevent a difference region from including a difference caused by camera shake or the like. Furthermore, if a moving object is included in a background, an image region including the moving object is detected as a difference region. In such a case, by detecting a difference region after turning a captured image at a predetermined return ratio and generating a captured image with lowered levels of noise and motion, the influence of the moving object can be prevented.

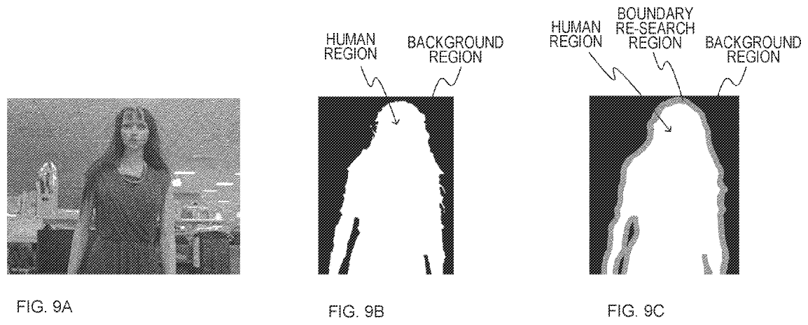

Next, mask generation processing will be described. FIG. 9 is a diagram for describing mask generation processing. (a) of FIG. 9 exemplifies a captured image obtained after down-sampling. Furthermore, (b) of FIG. 9 exemplifies a filter-processed segmentation map corresponding to a trimmed image. A black region is a background region and a white region is a human region.

The mask generation processing unit 33 generates a Trimap illustrated in (c) of FIG. 9, by providing a boundary re-search region by moving a boundary between the human region and the background region in the segmentation map away from a boundary line by a predetermined distance corresponding to a preset foreground side distance and background side distance. Note that a black region is a background region, a white region is a human region, and a region with intermediate luminance is a boundary re-search region.

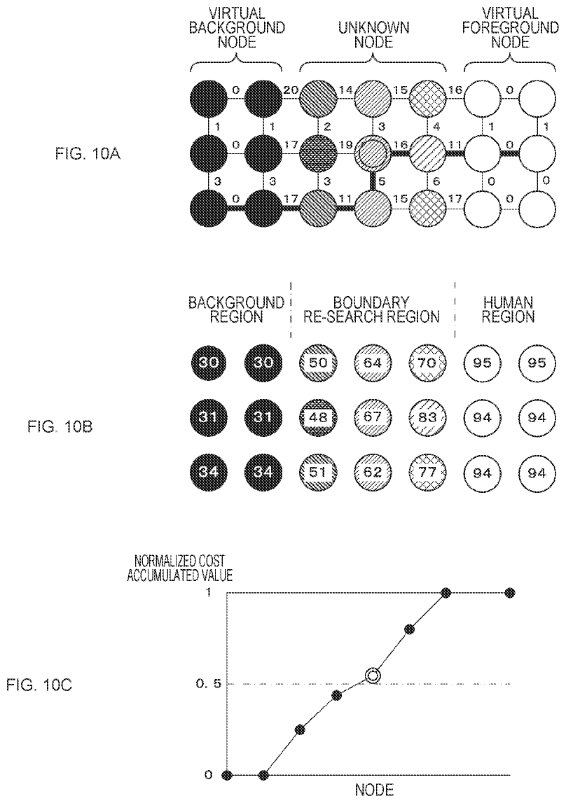

Next, the mask generation processing unit 33 generates a cost map on the basis of the Trimap. FIG. 10 is a diagram for describing generation of a cost map. As illustrated in (a) of FIG. 10, all pixels in the human region are set as virtual foreground nodes, and all pixels in the background region are set as virtual background nodes. Furthermore, pixels in the boundary re-search region are set as unknown nodes. (b) of FIG. 10 exemplifies pixel values in the human region, the background region, and the boundary search region.

The mask generation processing unit 33 forms a Markov random field by connecting nodes and edges of four neighboring pixels, for example. In the graph of the Markov random field, for example, cost CostAB at an edge AB between a node A and a node B is calculated on the basis of Formula (1). Note that, in Formula (1), “ColorDiffAB” is a difference in pixel value between the node A and the node B, “DistAB” is a distance between the node A and the node B (for example, a distance between four neighboring pixels is “1”), and “J” and “K” are preset parameters for adjusting cost.

CostAB=J×(ColorDiffAB+K×DistAB) (1)

The mask generation processing unit 33 detects a least cost path connecting virtual foreground nodes and virtual background nodes, using the Dijkstra's algorithm, the Bellman-Ford algorithm, or the like, for example. Note that, in (b) of FIG. 10, a path indicated by a bold line is a least cost path.

Moreover, a normalized cost accumulated value in the least cost path that is obtained when the mask generation processing unit 33 sets cost at the position of a background mask to “0” and cost at the position of a human mask to “1”, for example, is illustrated in (c) of FIG. 10. Thus, an unknown node indicated by a double circle, at which a normalized cost accumulated value is close to a determination criterion value such as “0.5”, is set as a boundary pixel. Note that the determination criterion value may be a fixed value, or may be changeable in accordance with the characteristic of the electronic device 10.

Furthermore, a cost map indicating which of a human region and a background region each pixel in a captured image represents is generated by searching for a least cost path for each of virtual foreground nodes and virtual background nodes, determining a boundary pixel on the basis of a cost accumulated value of a retrieved path, and setting a pixel position of the determined boundary pixel as a boundary. Note that a boundary pixel may be a pixel in the human region, or may be a pixel in the background region.

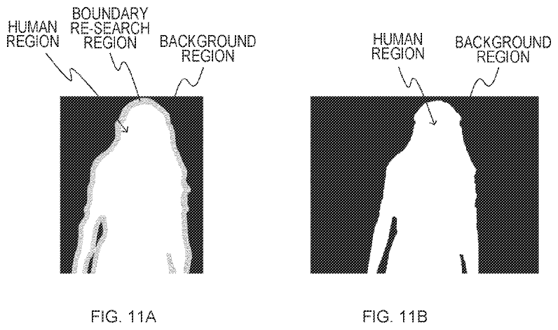

FIG. 11 exemplifies a cost map. (a) of FIG. 11 exemplifies a Trimap, and (b) of FIG. 11 exemplifies a cost map generated using a captured image and a Trimap that have been subjected to down-sampling. In this manner, the mask generation processing unit 33 can generate a cost map in which a new boundary that is based on a cost value of a shortest path in the boundary re-search region is set, a human region and a background region are determined more accurately than the segmentation map illustrated in (b) of FIG. 9, and a boundary line between the human region and the background region is smooth.

Note that the generation of a cost map is not limited to the above-described method. For example, a foreground cost map is generated using foreground nodes and unknown nodes, and a background cost map is further generated using background nodes and unknown nodes. Moreover, integration and normalization of the foreground cost map and the background cost map are performed. A cost map may be generated in this manner.

The mask generation processing unit 33 generates a human mask with resolution equal to a captured image by performing map conversion into a Trimap that is based on the reset boundary, performing up-sampling, generating a cost map on the basis of the up-sampled Trimap, and then further performing up-sampling.

Next, a filter operation will be described. The filtering unit 35 of the image processing unit 30 performs filter processing of a captured image using a human mask and blurring filter coefficients. In the filter processing, the number of taps and filter coefficients (human filter coefficient and background filter coefficient) of filter processing are set. Furthermore, in the filter processing, by controlling the human filter coefficient and the background filter coefficient on the basis of the human mask, while maintained the sharp edge of a human region, color mixture from one of the background region and the human region to another region is prevented in such a manner that a boundary between the human region and the background region does not look unnatural.

For example, the filtering unit 35 sets filter coefficients of an impulse response as human filter coefficients, sets lowpass filter coefficients as blurring filter coefficients, and switches filter coefficients to human filter coefficients in the human region and to blurring filter coefficients in the background region on the basis of the human mask.

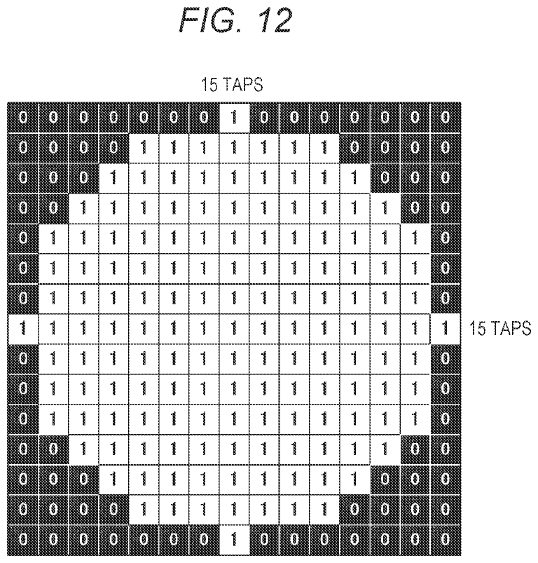

FIG. 12 exemplifies filter coefficients to be used in filter processing, and illustrates blurring filter coefficients for generating spherical defocus, for example. Note that filter coefficients are 15×15 taps, for example.

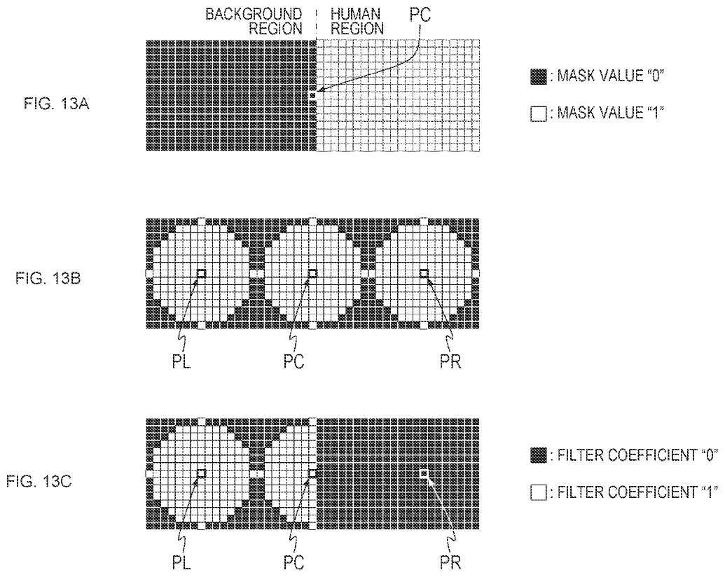

FIG. 13 exemplifies filter coefficients of a boundary portion of a human region and a background region. (a) of FIG. 13 illustrates a human mask, and illustrates that pixels with a mask value of “0” represent the background region, and pixels with a mask value of “1” represent the human region. (b) of FIG. 13 illustrates background filter coefficients. As the background filter coefficients, for example, blurring filter coefficients illustrated in FIG. 12 are repeated used, and the center of the background filter coefficients is set at a position PC (thick black frame pixel position) existing on the background region side at the boundary between the human region and the background region. (c) of FIG. 13 exemplifies filter coefficients obtained after masking.

In a case where the human mask is as illustrated in (a) of FIG. 13, in a case where a filter center is at a position PL, because the human mask corresponding to all filter coefficients are “0”, all background filter coefficients may be applied to a captured image. Furthermore, in a case where a filter center is at a position PR, because the human mask corresponding to all filter coefficients are “1”, all background filter coefficients are not to be applied to the captured image. In a case where a filter center is at the position PC, the background filter coefficients stride over a boundary between a human region and a background region, and background filter coefficients in a region where the human mask is “0” may be applied to the captured image, but background filter coefficients in a region where the human mask is “1” are not to be applied to the captured image. In other words, as illustrated in (c) of FIG. 13, background filter coefficients mask multiplication of pixel values in the captured image by a complement number of “1” of the human mask, and human filter coefficients mask the multiplication by the human mask.

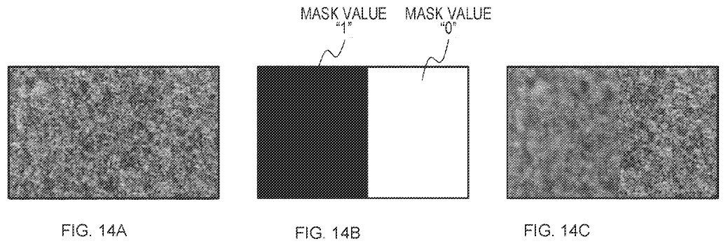

FIG. 14 exemplifies an image not subjected to filter processing and an image having been subjected to filter processing, and the like. (a) of FIG. 14 exemplifies a captured image not subjected to filter processing. Furthermore, (b) of FIG. 14 exemplifies a mask image. Here, a black region of the mask image is a region with a mask value of “1”, and a white region is a region with a mask value of “0”. If filter processing of the captured image illustrated in (a) of FIG. 14 is performed using the mask image, as illustrated in FIG. 14(c), the captured image having been subjected to filter processing becomes an image in which the sharp edge is maintained in the region with a mask value of “0”, and defocus occurs in the region with a mask value of “1”.

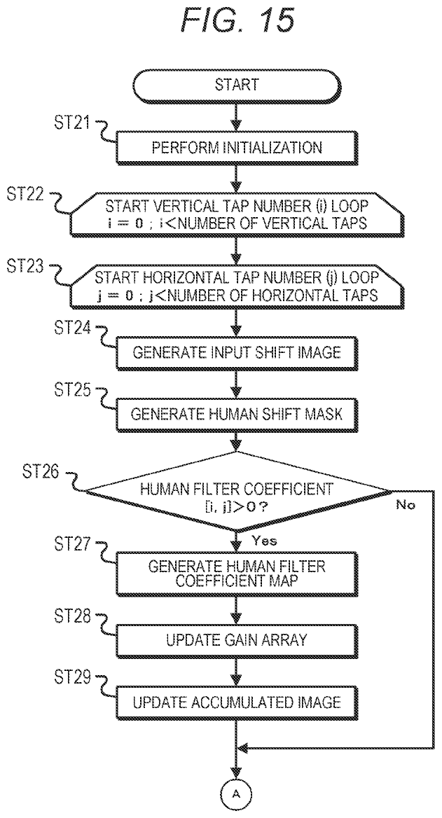

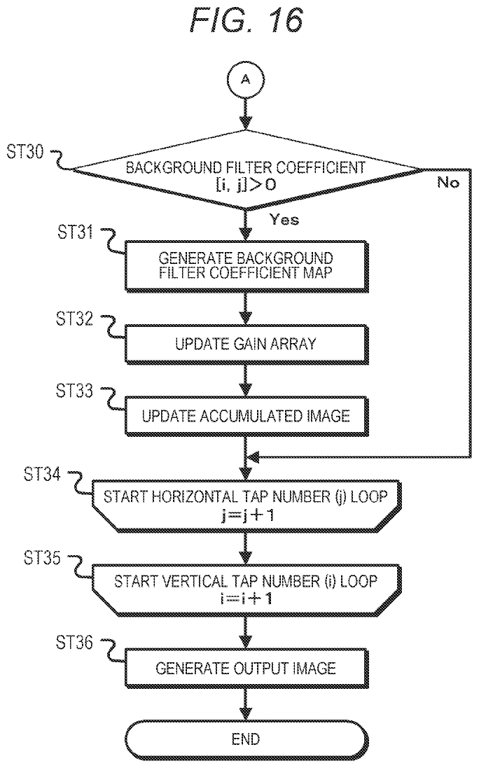

FIGS. 15 and 16 are flowcharts exemplifying a filter processing operation. In the filter processing operation, for each component of filter coefficients, a human filter coefficient map and a background filter coefficient map are generated on the basis of a human mask, human filter coefficients, and background filter coefficients (blurring filter coefficients). The human filter coefficient map is generated by multiplying the human mask by human filter coefficients, and the background filter coefficient map is generated by multiplying a complement number of 1 of the human mask by background filter coefficients. Furthermore, in the filter processing, an image of the human region is generated on the basis of the human filter coefficient map and a captured image, an image of the background region is generated on the basis of the background filter coefficient map and the captured image, and the captured image having been subjected to filter processing is generated by accumulating the image of the human region and the image of the background region of each component of filter coefficients for each pixel. The filtering unit 35 performs such generation of the human filter coefficient map, the background filter coefficient map, and the background filter coefficient map, and the generation of the image of the human region and the image of the background region in a unit of a screen, and generates a captured image.

In Step ST21, the filtering unit performs initialization. The filtering unit 35 sets each pixel value of an accumulated image and each gain of a gain array to a default value of “0”, and the processing proceeds to Step ST22. Note that, in the following description, a pixel position (address) is represented as [y, x] by setting a parameter x to “0≤x<image horizontal size Sh”, and a parameter y to “0≤y<image vertical size Sv”.

In Step ST22, the filtering unit starts a loop of a vertical tap number (i), and the processing proceeds to Step ST23. Note that the parameter i is “0≤i<the number of vertical taps”.

In Step ST23, the filtering unit starts a loop of a horizontal tap number (j), and the processing proceeds to Step ST24. Note that the parameter j is “0≤i<the number of horizontal taps”.

In Step ST24, the filtering unit generates an input shift image. The filtering unit 35 sets a pixel value at a coordinate position [y+i−the number of vertical taps/2, x+j−the number of horizontal taps/2] in the captured image as a pixel value of the input shift image [y, x]. The filtering unit 35 generates the input shift image by performing the processing at each pixel position (each position within the range of “0≤x<Sh, 0≤y<Sv”), and the processing proceeds to Step ST25.

In Step ST25, the filtering unit generates a human shift mask. The filtering unit 35 sets a mask value at a coordinate position [y+i−the number of vertical taps/2, x+j−the number of horizontal taps/2] of the human mask as a mask value of the human shift mask [y, x]. The filtering unit 35 generates the human shift mask by performing the processing at each pixel position, and the processing proceeds to Step ST26.

In Step ST26, the filtering unit determines whether or not a human filter coefficient [i, j] is larger than “0”. In a case where the human filter coefficient [i, j] is larger than “0”, the filtering unit 35 advances the processing to Step ST27, and in a case where the human filter coefficient [i, j] is “0”, the processing proceeds to Step ST30.

In Step ST27, the filtering unit generates a human filter coefficient map. The filtering unit 35 performs multiplication of a coefficient value of the human filter coefficient [y, x] and a mask value of the human shift mask [y, x], and sets a multiplication result as a map value of the human filter coefficient map [y, x]. The filtering unit 35 generates the human filter coefficient map by performing the processing at each pixel position, and the processing proceeds to Step ST28.

In Step ST28, the filtering unit updates a gain array. The filtering unit 35 adds a gain value of a gain array [y, x] and the map value of the human filter coefficient map [y, x], and sets an addition result as a gain value of a new gain array [y, x]. The filtering unit 35 updates the gain array by performing the processing at each pixel position, and the processing proceeds to Step ST29.

In Step ST29, the filtering unit updates the accumulated image. The filtering unit 35 adds a pixel value of the accumulated image [y, x] to a multiplication result of a pixel value of the input shift image [y, x] and a map value of the human filter coefficient map [y, x], and sets an addition result as a new pixel value of the accumulated image [y, x]. The filtering unit 35 updates the accumulated image by performing the processing at each pixel position, and the processing proceeds to Step ST30.

In Step ST30 of FIG. 16, the filtering unit determines whether or not a background filter coefficient [i, j] is larger than “0”. In a case where the background filter coefficient [i, j] is larger than “0”, the filtering unit 35 advances the processing to Step ST31, and in a case where the background filter coefficient [i, j] is “0”, the processing proceeds to Step ST34.

In Step ST31, the filtering unit generates a background filter coefficient map. The filtering unit 35 performs multiplication of a coefficient value of the background filter coefficient [i, j] and a mask value of (1−human shift mask [y, x]), and sets a multiplication result as a map value of the background filter coefficient map [y, x]. The filtering unit 35 generates the background filter coefficient map by performing the processing at each pixel position, and the processing proceeds to Step ST32.

In Step ST32, the filtering unit updates a gain array. The filtering unit 35 adds a gain value of a gain array [y, x] and the map value of the background filter coefficient map [y, x], and sets an addition result as a gain value of a new gain array [y, x]. The filtering unit 35 updates the gain array by performing the processing at each pixel position, and the processing proceeds to Step ST33.

In Step ST33, the filtering unit updates the accumulated image. The filtering unit 35 adds a pixel value of the accumulated image [y, x] to a multiplication result of a pixel value of the input shift image [y, x] and a map value of the background filter coefficient map [y, x], and sets an addition result as a new pixel value of the accumulated image [y, x]. The filtering unit 35 updates a pixel value of the accumulated image by performing the processing at each pixel position, and the processing proceeds to Step ST34.

In Step ST34, the filtering unit updates a horizontal tap number (j). The filtering unit 35 adds “1” to the horizontal tap number, and repeats the processing in Steps ST23 to ST34 until the updated horizontal tap number (j) becomes the number of horizontal taps, and then the processing proceeds to Step ST35.

In Step ST35, the filtering unit updates a vertical tap number (i). The filtering unit 35 adds “1” to the vertical tap number, and repeats the processing in Steps ST22 to ST35 until the updated vertical tap number (i) becomes the number of vertical taps, and then the processing proceeds to Step ST36.

In Step ST36, the filtering unit 35 generates an output image. The filtering unit 35 divides a pixel value of the accumulated image [y, x] by a gain value of the gain array, and sets a division result as a pixel value of an output image [y, x]. The filtering unit 35 generates an output image by performing the processing at each pixel position.

In this manner, FIGS. 15 and 16 illustrate a processing flow that can apply a human mask for each coefficient of a human filter and a background filter. Furthermore, in a case where a coefficient is “0”, because the setting of a filter coefficient map and update of a gain array and an accumulated image are skipped, a processing amount can be reduced. Furthermore, by performing the processing while parallelizing the processing for each pixel or each component number of filter coefficients using a parallel processor of a graphics processing unit (GPU) or the like, the filter processing can be performed at high speed.

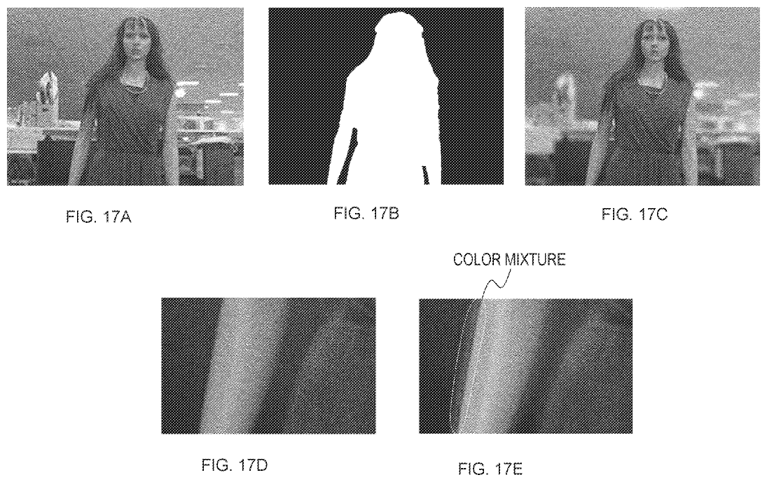

FIG. 17 exemplifies a captured image, a human mask image, and an output image. According to the present technology, from a captured image illustrated in (a) of FIG. 17, a human mask illustrated in (b) of FIG. 17, in which a human region is detected more accurately as compared with a case where a human region is detected by semantic segmentation can be generated. Moreover, by performing filter processing of the captured image using a human mask and blurring filter coefficients (or human mask, blurring filter coefficients, and human filter coefficients), as illustrated in (c) of FIG. 17, an output image in which only a background region is brought into a desired blurred state can be generated. Furthermore, in the output image generated by the present technology, as illustrated (d) of FIG. 17 that illustrates a part of the captured image illustrated in (c) of FIG. 17, in an enlarged manner, a boundary between a human region and a background region is clear, and color mixture (color spreading) or the like at a boundary portion can be reduced as compared with an image illustrated in (e) of FIG. 17 that has been acquired using a conventional image processing method of performing a blend processing at a boundary portion.

In this manner, according to the present technology, because a non-target region blurred image can be generated from a captured image, in a case where an imaging plane of an image sensor is small, or even in the case of using an electronic device that acquires a captured image in which a focus is put not only on a target region (for example, human region) but also on a non-target region (for example, background region), due to a deep depth of field of an imaging optical system, similarly to the case using a single-lens reflex camera, a background blurred image with a small amount of artifact can be easily and promptly obtained. Furthermore, because blurring filter coefficients and the number of taps of a filter are switchable, for example, the user can bring a background into a preferred defocus state.

Furthermore, in the above-described embodiment, the description has been given of a case where a target region is an image region representing a human, and a non-target region is an image region representing a background, but a target region is not limited to human, and may be an image region representing animals, plants, structural objects, and the like. Furthermore, a non-target region is not limited to the background, and may be an image region representing a foreground.

A series of processes described in the specification can be executed by hardware, software, or a composite configuration of these. In a case where processing is executed by software, the processing can be executed by installing a program on which a processing sequence is recorded, onto a memory in a computer incorporated in dedicated hardware. Alternatively, the program can be executed by being installed onto a general-purpose computer that can execute various types of processing.

For example, the program can be preliminarily recorded onto a hard disc, a solid state drive (SSD), or read only memory (ROM) that serves as a recording medium. Alternatively, the program can be temporarily or permanently stored (recorded) onto a removable recording medium such as a flexible disk, a compact disc read only memory (CD-ROM), a magneto optical (MO) disk, a digital versatile disc (DVD), a Blu-Ray Disc (BD (registered trademark)), a magnetic disk, or a semiconductor memory card. Such a removable recording medium can be provided as so-called shrink-wrapped software.

Furthermore, aside from being installed from a removable recording medium onto a computer, the program may be transferred from a download site to a computer wirelessly or in a wired manner via a network such as a local area network (LAN) or the Internet. In the computer, a program transferred in this manner can be received, and installed onto a recording medium such as an internal hard disc.

Note that effects described in this specification are mere exemplifications and are not limited, and undescribed additional effects may be caused. Furthermore, the present technology is not to be construed as being limited to the embodiment of the above-described technology. The embodiment of the present technology discloses the present technology in the form of exemplification, and it is obvious that the one skilled in the art can modify or substitute the embodiment without departing from the gist of the present technology. In other words, for determining the gist of the present technology, the appended claims are to be referred to.

Furthermore, the image processing apparatus of the present technology can employ the following configurations.

(1) An image processing apparatus including:

a mask generation unit configured to detect a target region from a captured image, and generate a target region mask from features of the target region and a non-target region different from the target region; and a filtering unit configured to generate a non-target region blurred image by performing filter processing of the captured image using the target region mask generated by the mask generation unit, and a blurring filter coefficient.

(2) The image processing apparatus according to (1), in which the mask generation unit detects the target region using a region determination result obtained by semantic segmentation.

(3) The image processing apparatus according to (2), in which the mask generation unit resets a boundary between the target region and the non-target region on the basis of continuity of a pixel value of the captured image, in a boundary re-search region set to include the target region and the non-target region on the basis of a boundary between the target region and the non-target region that is indicated by the region determination result, and generates the target region mask using the reset boundary.

(4) The image processing apparatus according to (2) or (3), in which the mask generation unit detects a difference region between the captured image used in semantic segmentation, and a captured image including the target region partially different from that of the captured image, and generates the region determination result by synthesizing a target region determined in the semantic segmentation, and the difference region.

(5) The image processing apparatus according to (4), in which a captured image including the target region partially different from that of the captured image is a captured image obtained by capturing an image of a targeted subject, and a captured image used in the semantic segmentation is a captured image obtained by capturing an image of the subject, in which only a predetermined portion of the targeted subject is moved to a position not overlapping the non-target region.

(6) The image processing apparatus according to any of (1) to (5), in which the non-target region is a background region.

(7) The image processing apparatus according to any of (1) to (6), in which a blurring filter coefficient to be used by the filtering unit is switchable to a blurring filter coefficient with a different blurring characteristic.

(8) The image processing apparatus according to any of (1) to (8), in which the filtering unit makes the number of taps of the filter processing switchable.

(9) The image processing apparatus according to any of (1) to (8), in which the filtering unit performs filter processing of a region in the captured image that corresponds to the target region mask, using the target region mask and a target region filter coefficient.

(10) The image processing apparatus according to (9), in which the filtering unit sets a filter coefficient of an impulse response as the target region filter coefficient, sets a lowpass filter coefficient as the blurring filter coefficient, and switches a filter coefficient to the target region filter coefficient in the target region and to the blurring filter coefficient in the non-target region on the basis of the target region mask.

(11) The image processing apparatus according to (9), in which the filtering unit performs generation of a target region filter coefficient map and a non-target region filter coefficient map on the basis of the target region mask, the target region filter coefficient, and the blurring filter coefficient for each component of a filter coefficient, generates a target region image on the basis of the target region filter coefficient map and the captured image, generates a non-target region image on the basis of the non-target region filter coefficient map and the captured image, and performs filter processing by accumulating the target region image and the non-target region image of each component of the filter coefficient for each pixel.

### REFERENCE SIGNS LIST

10 Electronic device
20 Imaging unit
21 Imaging optical system
22 Image sensor unit
30 Image processing unit
31 Mask generation unit
32 Human region detection unit
33 Mask generation processing unit
34 Filter setting unit
35 Filtering unit
40 Display unit
50 User interface unit
60 Control unit
321, 332 Down-sampling unit
322 Segmentation unit
323 Resize unit
331 Preprocessing unit
333 Map conversion unit
334, 336 Boundary resetting unit
335, 337 Up-sampling unit
3341, 3361 Cost map generation unit
3341a Node setting unit
3341b Internode cost calculation unit
3341c Least cost path search unit
3341d Cost map generation processing unit
3342 Cost map conversion processing unit
3362 Binarization processing unit

1. An image processing apparatus comprising:
a mask generation unit configured to detect a target region from a captured image, and generate a target region mask from features of the target region and a non-target region different from the target region; and
a filtering unit configured to generate a non-target region blurred image by performing filter processing of the captured image using the target region mask generated by the mask generation unit, and a blurring filter coefficient.

2. The image processing apparatus according to claim 1, wherein
the mask generation unit detects the target region using a region determination result obtained by semantic segmentation.

3. The image processing apparatus according to claim 2, wherein
the mask generation unit resets a boundary between the target region and the non-target region on a basis of continuity of a pixel value of the captured image, in a boundary re-search region set to include the target region and the non-target region on a basis of a boundary between the target region and the non-target region that is indicated by the region determination result, and generates the target region mask using the reset boundary.

4. The image processing apparatus according to claim 2, wherein
the mask generation unit detects a difference region between the captured image used in semantic segmentation, and a captured image including the target region partially different from that of the captured image, and generates the region determination result by synthesizing a target region determined in the semantic segmentation, and the difference region.

5. The image processing apparatus according to claim 4, wherein
a captured image including the target region partially different from that of the captured image is a captured image obtained by capturing an image of a targeted subject, and a captured image used in the semantic segmentation is a captured image obtained by capturing an image of the subject, in which only a predetermined portion of the targeted subject is moved to a position not overlapping the non-target region.

6. The image processing apparatus according to claim 1, wherein
the non-target region is a background region.

7. The image processing apparatus according to claim 1, wherein
a blurring filter coefficient to be used by the filtering unit is switchable to a blurring filter coefficient with a different blurring characteristic.

8. The image processing apparatus according to claim 1, wherein
the filtering unit makes the number of taps of the filter processing switchable.

9. The image processing apparatus according to claim 1, wherein
the filtering unit performs filter processing of a region in the captured image that corresponds to the target region mask, using the target region mask and a target region filter coefficient.

10. The image processing apparatus according to claim 9, wherein
the filtering unit sets a filter coefficient of an impulse response as the target region filter coefficient, sets a lowpass filter coefficient as the blurring filter coefficient, and switches a filter coefficient to the target region filter coefficient in the target region and to the blurring filter coefficient in the non-target region on a basis of the target region mask.

11. The image processing apparatus according to claim 9, wherein
the filtering unit performs generation of a target region filter coefficient map and a non-target region filter coefficient map on a basis of the target region mask, the target region filter coefficient, and the blurring filter coefficient for each component of a filter coefficient, generates a target region image on a basis of the target region filter coefficient map and the captured image, generates a non-target region image on a basis of the non-target region filter coefficient map and the captured image, and performs filter processing by accumulating the target region image and the non-target region image of each component of the filter coefficient for each pixel.

12. An image processing method comprising:
detecting a target region from a captured image, and generating a target region mask from features of the target region and a non-target region different from the target region, by a mask generation unit; and
generating a non-target region blurred image by a filtering unit by performing filter processing of the captured image using the target region mask generated by the mask generation unit, and a blurring filter coefficient.

13. A program for causing a computer to execute image processing of a captured image, the program causing the computer to execute:
a procedure of detecting a target region from the captured image, and generating a target region mask from features of the target region and a non-target region different from the target region; and
a procedure of generating a non-target region blurred image by performing filter processing of the captured image using the target region mask and a blurring filter coefficient.

14. An electronic device comprising:
an imaging unit configured to generate a captured image;
a mask generation unit configured to detect a target region from the captured image, and generate a target region mask from features of the target region and a non-target region different from the target region;
a filtering unit configured to generate a non-target region blurred image by performing filter processing of the captured image using the target region mask generated by the mask generation unit, and a blurring filter coefficient; and
a display unit configured to display the non-target region blurred image.
